(19) United States
(12) Patent Application Publication
(10) Pub. No.: US 2020/0379328 A1
(43) Pub. Date: Dec. 3, 2020

(54) ILLUMINATION SYSTEM

(71) Applicant: DELTA ELECTRONICS, INC., Taoyuan City (TW)

(72) Inventor: Hung-Ying LIN, Taoyuan City (TW)

(21) Appl. No.: 16/675,198

(22) Filed: Nov. 5, 2019

(30) Foreign Application Priority Data
May 30, 2019 (CN) 201910463706.4

(51) Int. Cl. G03B 21/20; G02B 26/00; G03B 21/28

(52) U.S. Cl. CPC G03B 21/204; G02B 26/008; G03B 21/16; G03B 21/2013; G03B 21/28; G03B 21/206

(57) ABSTRACT

An illumination system includes a light source, a reflective member, a lens set and a phosphor wheel. The light source is configured to emit a first light. The reflective member is configured to reflect at least part of the first light. The lens set is configured to converge the first light reflected by the reflective member. The phosphor wheel and the reflective member are positioned on two opposite sides of the lens set. The phosphor wheel has a first section to which the first light converges. The first section is configured to provide a second light. The second light is configured to pass through the lens set to define a light passage region. The reflective member is at least partially located within the light passage region.

### RELATED APPLICATIONS

This application claims priority to China Application Serial Number 201910463706.4, filed May 30, 2019, the disclosure of which is incorporated herein by reference in its entirety.

### BACKGROUND

### Technical Field

The present disclosure relates to an illumination system.

### Description of Related Art

Illumination system of a projector is equipped with a phosphor wheel to provide light of different colors. A typical phosphor wheel has a notch for a blue laser emitted by a laser light source to pass through. However, such a phosphor wheel is of greater manufacturing complexity and requires optical components on both its front and rear sides, such that there is typically not enough space available to the phosphor wheel to dissipate heat effectively. In addition, the illumination system must incorporate additional optical components to redirect the blue light passing through the phosphor wheel, resulting in a bulky system with high manufacturing cost. Another drawback is the reduction in brightness of the blue light, which results from the loss incurred by the blue light as it passes through the additional optical components.

### SUMMARY

One of the objects of the present disclosure is to provide a novel illumination system to resolve the aforementioned issues.

In accordance with an embodiment of the present disclosure, an illumination system includes a first light source, a reflective member, a lens set and a phosphor wheel. The first light source is configured to emit a first light. The reflective member is configured to reflect at least part of the first light. The lens set is configured to converge the first light reflected by the reflective member. The phosphor wheel and the reflective member are positioned on two opposite sides of the lens set. The phosphor wheel has a first section to which the first light converges. The first section is configured to provide a second light. The second light is configured to pass through the lens set to define a light passage region. The reflective member is at least partially located within the light passage region.

In one or more embodiments of the present disclosure, the first section is a reflective section. The first light is configured to be reflected by the reflective section to form the second light.

In one or more embodiments of the present disclosure, the phosphor wheel further includes a second section configured to absorb at least part of the first light and emit a third light. The first light and the third light differs in wavelength. The third light is configured to pass through the lens set and enter the light passage region.

In one or more embodiments of the present disclosure, each of the first light and the second light is blue light. The second section includes at least one of: a red fluorescent material, a green fluorescent material and a yellow fluorescent material.

In one or more embodiments of the present disclosure, the reflective section includes at least one of: white glue, white glue mixed with fluorescent powder, a fluorescent powder layer, a dielectric coating, a metallic reflective layer and a reflective optical film.

In one or more embodiments of the present disclosure, the phosphor wheel includes a reflective substrate. The reflective section is located on the reflective substrate.

In one or more embodiments of the present disclosure, the first section is a wavelength conversion section configured to absorb at least part of the first light and emit the second light. The first light and the second light differ in wavelength.

In one or more embodiments of the present disclosure, the first light is ultraviolet. The wavelength conversion section includes at least one of: a red fluorescent material, a green fluorescent material, a blue fluorescent material and a yellow fluorescent material.

In one or more embodiments of the present disclosure, the reflective member is a reflective mirror.

In one or more embodiments of the present disclosure, the reflective member is a beam splitter. The beam splitter has a filtering portion configured to reflect at least part of the first light and allow light of other colors to pass through.

In one or more embodiments of the present disclosure, an area of the filtering portion is less than 70% of a cross sectional area of the light passage region.

In one or more embodiments of the present disclosure, the first section is a reflective section. The first light is configured to be reflected by the reflective region to form the second light. The first light includes a first polarized light. The second light includes the first polarized light and a second polarized light. The second polarized light and the first polarized light have orthogonal directions of polarization. The filtering portion is configured to reflect the first polarized light and to allow the second polarized light to pass through.

In one or more embodiments of the present disclosure, the illumination system further includes a dichroic filter and a second light source. The dichroic filter and the lens set are located on two opposite sides of the reflective member. The second light source is configured to emit a fourth light. The fourth light is configured to be reflected by a surface of the dichroic filter that faces away from the reflective member. The fourth light after reflection at the surface and the second light in the light passage region travel in the same direction.

In sum, the illumination system of the present disclosure is of reflective design. All light paths are located on the receiving side of the phosphor wheel such that there is no need for additional optical components on the rear side of the phosphor wheel. This results in significant reduction in the size, weight and cost of the illumination system, meanwhile providing enough space for the phosphor wheel to dissipate heat.

### BRIEF DESCRIPTION OF THE DRAWINGS

To make the objectives, features, advantages, and embodiments of the present disclosure, including those mentioned above and others, more comprehensible, descriptions of the accompanying drawings are provided as follows.

FIG. 1 illustrates a side view of an illumination system in accordance with an embodiment of the present disclosure;

FIG. 2 illustrates a top view of the phosphor wheel shown in FIG. 1;

FIG. 3 illustrates a top view of a phosphor wheel in accordance with another embodiment of the present disclosure;

FIG. 4 illustrates a front view of the reflective member shown in FIG. 1;

FIG. 5 illustrates a side view of an illumination system in accordance with another embodiment of the present disclosure;

FIG. 6 illustrates a top view of a phosphor wheel in accordance with another embodiment of the present disclosure; and

FIG. 7 illustrates a top view of a phosphor wheel in accordance with another embodiment of the present disclosure.

### DETAILED DESCRIPTION

For the sake of the completeness of the description of the present disclosure, reference is made to the accompanying drawings and the various embodiments described below. Various features in the drawings are not drawn to scale and are provided for illustration purposes only. To provide full understanding of the present disclosure, various practical details will be explained in the following descriptions. However, a person with an ordinary skill in relevant art should realize that the present disclosure can be implemented without one or more of the practical details. Therefore, the present disclosure is not to be limited by these details.

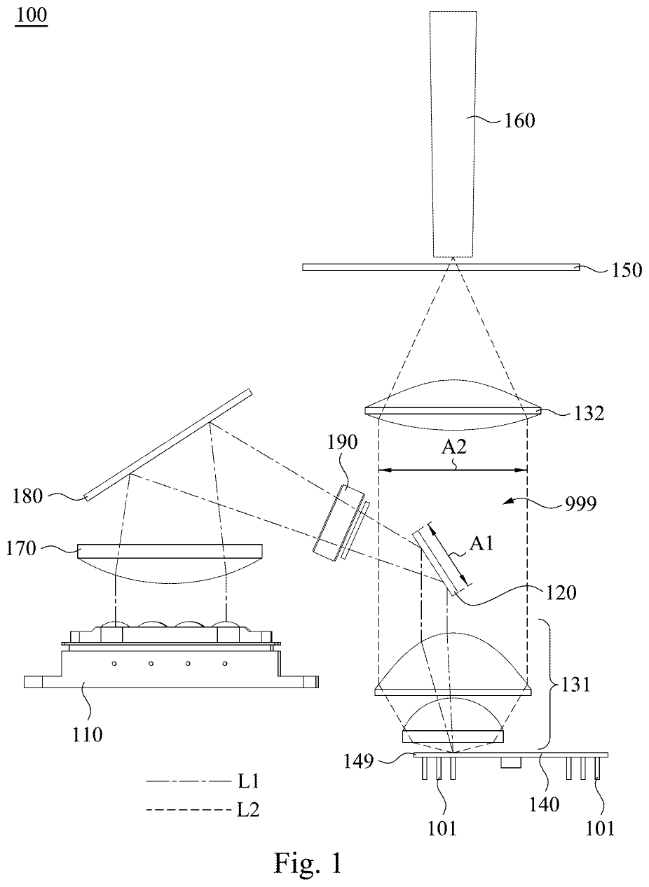

Reference is made to FIG. 1, which illustrates a side view of an illumination system 100 in accordance with an embodiment of the present disclosure. For example, the illumination system 100 may be incorporated into a projector to provide illumination for the projector. The illumination system 100 includes a first light source 110, a reflective member 120, a first lens set 131, a phosphor wheel 140, a second lens set 132, a color wheel 150, and a light pipe 160. The first light source 110 is configured to emit a first light which travels along a first light path L1 (only the outermost light path is depicted). The reflective member 120 is on the first light path L1 and is configured to reflect at least part of the first light. The first light reflected by the reflective member 120 travels along the first light path L1 towards the first lens set 131.

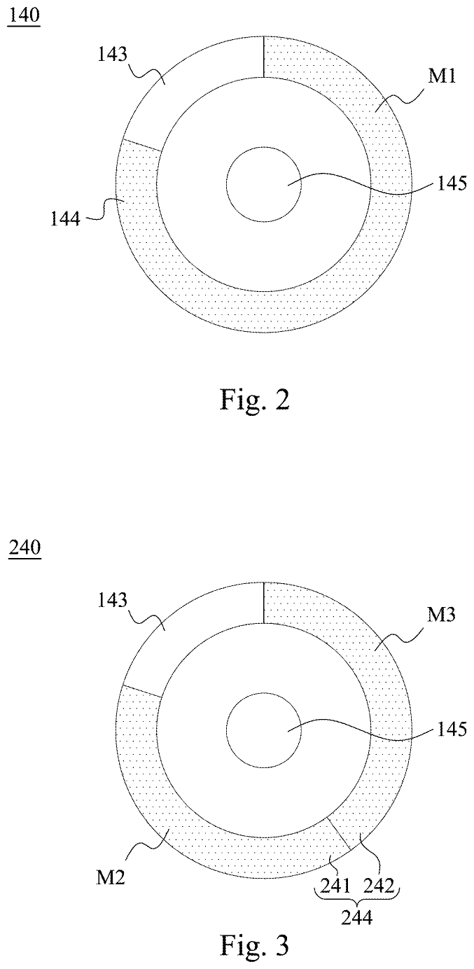

As shown in FIG. 1, the first lens set 131 receives the first light reflected by the reflective member 120 and converges the first light to the phosphor wheel 140. In some embodiments, the first lens set 131 includes collimating lens. The phosphor wheel 140 is located on a side of the first lens set 131 away from the reflective member 120, in other words, the phosphor wheel 140 and the reflective member 120 are located on two opposite sides of the first lens set 131 respectively. The phosphor wheel 140 has a first section 143 (see FIG. 2; will be discussed in detail below). The first section 143 is configured to provide a second light which travels along a second light path L2 (only the outermost light path is depicted).

As shown in FIG. 1, after passing thought the first lens set 131, the second light becomes parallel light rays. Said parallel light rays define a light passage region 999. The reflective member 120 is at least partially located within the light passage region 999. The second lens set 132, the color wheel 150 and the light pipe 160 are arrange in the specified order on a side of the reflective member 120 away from the first lens set 131. The second lens set 132 is configured to receive the second light passing through the light passage region 999 and to converge the second light to the color wheel 150. The second light is filtered by the color wheel 150 and enters the light pipe 160 behind the color wheel 150 to provide illumination. In some embodiments, a cross section area of the light passage region 999 substantially matches that of the lens farthest from the phosphor wheel 140 (and with the largest diameter) in the first lens set 131.

The illumination system 100 of the present disclosure adopts reflective design, such that the first light path L1 along which the first light travels and the second light path L2 along which the second light travels are both on the receiving side of the phosphor wheel 140 (i.e., the side of the phosphor wheel 140 facing the first lens set 131), eliminating the need for installing optical component(s) behind the phosphor wheel 140 to guide the first light and thus creating enough space for the phosphor wheel 140 to dissipate heat. In some embodiments, the illumination system 100 further includes a heatsink 101 disposed on a side of the phosphor wheel 140 away from the first lens set 131. For example, the heatsink 101 may include multiple fins in radial arrangement and in contact with the phosphor wheel 140. The phosphor wheel 140 takes advantage of the enlarged surface area of the heatsink 101 to dissipate heat more effectively.

Reference is made to FIG. 2, which illustrates a top view of the phosphor wheel 140 shown in FIG. 1. In some embodiments, the first light source 110 is a blue laser and the first light is blue light accordingly. The phosphor wheel 140 has a reflective substrate 149 (see FIG. 1). The first section 143 of the phosphor wheel 140 is a reflective section. The reflective section is arranged along the periphery of the phosphor wheel 140 and is located on the reflective substrate 149. The first light is reflected when being converged to the first section 143, in other words, the first light is reflected by the first section 143 to form the second light. Consequently, the second light is also blue light.

In some embodiments, the first light is diffusely reflected by the first section 143, such that the angle formed by the second light (reflected by the first section 143) is greater than the angle formed by the first light (incident on the first section 143). In some embodiments, the first section 143 includes white glue (which mainly includes reflective material such as titanium dioxide), white glue mixed with fluorescent powder, a fluorescent powder layer or optically reflective material such as a dielectric coating, a metallic reflective layer and a reflective optical film.

To enable the projector to display light of different colors, the illumination system 100 is required to provide light of color other than blue. As shown in FIG. 2, in some embodiments, the phosphor wheel 140 further has a second section 144 arranged along the periphery of the phosphor wheel 140. The phosphor wheel 140 is configured to rotate about a shaft 145, such that the first light is incident on the first section 143 and the second section 144 alternately. The second section 144 is a wavelength conversion section configured to provide a third light. Specifically, when the first light is converged to the second section 144, the second section 144 absorbs at least part of the first light and emits the third light (which is of greater wavelength than the first light) towards the first lens set 131. The third light travels along the second light path L2 towards the first lens set 131 and enters the light passage region 999 after passing through the first lens set 131.

In the present embodiment, the second section 144 includes a yellow fluorescent material M1 that absorbs at least part of the first light incident thereon and emits yellow light (i.e., the third light). Generally speaking, as compared to green light and red light (or yellow light, which is a mixture of green light and red light), projectors have lower demand for blue light. Consequently, in some embodiments, the area covered by the first section 143 is smaller than the area covered by the second section 144.

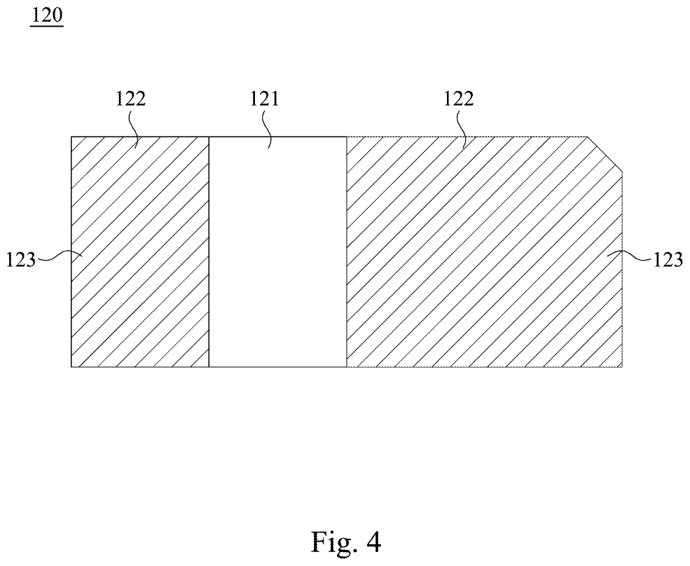

Reference is made to FIG. 3, which illustrates a top view of a phosphor wheel 240 in accordance with another embodiment of the present disclosure. The phosphor wheel 240 of the present embodiment may replace the phosphor wheel 140 in the illumination system 100. The phosphor wheel 240 differs from the embodiment shown in FIG. 2 (i.e., the phosphor wheel 140) in that the second section 244 of the phosphor wheel 240 includes a first subsection 241 and a second subsection 242. The first subsection 241 includes a green fluorescent material M2 that absorbs at least part of the first light incident thereon and emits green light. The second subsection 242 includes a red fluorescent material M3 that absorbs at least part of the first light incident thereon and emits red light. In some embodiments, both the area covered by the first subsection 241 and the area covered by the second subsection 242 are greater than the area covered by the first section 143.

Reference is made back to FIG. 1. Since the reflective member 120 is at least partially located within the light passage region 999, depending on the optical property of the reflective member 120, part of the second light and/or the third light would be reflected by the reflective member 120 and lost. In some embodiments, the reflective member 120 is a beam splitter with a filtering portion 121 (see FIG. 4). The filtering portion 121 is configured to reflect at least part of the first light (i.e. blue light) and allow light of other colors to pass through. Consequently, part of the second light (also blue light) entering the light passage region 999 is reflected by the filtering portion 121 and lost, and the rest of the second light passes around the filtering portion 121 and travels towards the second lens set 132. The transmittance of the filtering portion regarding the third light is high such that most of the third light passes through the reflective member 120 and reaches the second lens set thereafter. In some embodiments, an area A1 of the filtering portion 121 is less than 70% of a cross sectional area A2 of the light passage region 999. Preferably, the area A1 of the filtering portion 121 is less than 50% of the cross sectional area A2 of the light passage region 999.

For the illumination system 100 of the present disclosure, despite the loss of part of the second light (i.e., blue light) due to reflection by the filtering portion 121, the illumination system 100 gets rid of the additional optical components for guiding the first light (i.e., blue light) passing through the phosphor wheel found in conventional illumination systems and thereby eliminating the loss incurred by the first light when passing through the additional optical components. Consequently, the illumination system 100 is able to provide the first light with brightness on par with those of the conventional illumination systems, meanwhile reducing the size, weight and cost significantly.

In some embodiments, an angle of incidence of the first light on the filtering portion 121 is greater than 45 degrees. Under said angle of incidence, lights with different polarization behave distinctly in terms of the curve of transmittance to wavelength. Taking advantage of this property, the loss of blue light may be reduced by configuring the filtering portion 121 to allow blue light with certain polarization to pass through.

In some embodiments, the first light emitted by the first light source 110 consists of a first polarized light having a first direction of polarization. In other words, the first light provided by the first light source 110 is a polarized light. For example, the first polarized light may be a s-polarized blue light. The first light becomes unpolarized after being reflected by the first section 143 of the phosphor wheel 140. Thus, the second light provided by the first section 143 includes the first polarized light and a second polarized light with orthogonal directions of polarization. For example, the second polarized light may be p-polarized blue light. The filtering portion 121 is configured to reflect the first polarized light and to allow the second polarized light to pass through, thereby reducing the amount of blue light lost to reflection.

Reference is made to FIG. 4, which illustrates a front view of the reflective member 120 shown in FIG. 1. The edge of the reflective member 120 visible in FIG. 1 corresponds to the right edge of the reflective member 120 in the front view illustrated in FIG. 4. The reflective member 120 shown in FIG. 4 is a beam splitter. In addition to the filtering portion 121 discussed above, the reflective member 120 further has a transparent portion 122 on at least one side of the filtering portion 121. The transparent portion 122 may be held so as to allow the reflective member 120 to be fixed in place. To avoid blocking the second light and the third light provided by the phosphor wheel 140, the transparent portion 122 allows light of all colors to pass through. In some embodiments, the surface of the transparent portion 122 in proximity to the first lens set 131 is covered with anti-reflective coating 123 to reduce the reflection loss of the second light and the third light.

In some embodiments, the reflective member 120 may be a reflective mirror that is configured to reflect light of all colors. In such embodiments, the reflective member 120 is still capable of guiding the first light towards the phosphor wheel 140. Part of the second light and the third light travelling towards the reflective member 120 would be reflected and lost. Since only part of the cross section of the light passage region 999 is blocked by the reflective member 120, the rest of the second light and the third light can pass around the reflective member 120 and reach the second lens set 132.

Reference is made back to FIG. 1. In some embodiments, the illumination system 100 further includes a converging lens 170, a reflective mirror 180 and a light uniforming member 190. The converging lens 170 is located between the reflective mirror 180 and the first light source 110. The converging lens 170 is configured to converge the first light emitted by the first light source 110 to the reflective mirror 180. The light uniforming member 190 is on the first light path L1 and is configured to receive the first light reflected by the reflective mirror 180. The first light is incident uniformly on the reflective member 120 after passing through the light uniforming member 190. In some embodiments, the light uniforming member 190 is a diffuser.

In some embodiments, the first light source 110 is an ultraviolet laser and the first light emitted by the first light source 110 is ultraviolet accordingly. In such embodiments, the first section of the phosphor wheel 140 is a wavelength conversion section which includes at least one of: a red fluorescent material, a green fluorescent material, a blue fluorescent material and a yellow fluorescent material. In other words, the fluorescent material of the phosphor wheel 140 absorbs at least part of the ultraviolet and emits at least one of a red light, a green light, a blue light and a yellow light.

It is to be noted that the second lens set 132 is not limited to the single lens configuration shown in FIG. 1. The skilled person may configure the second lens set 132 with suitable number of lens and optical properties to converge the second light and the third light passing through the light passage region 999 at the color wheel 150. Similarly, the first lens set 131 is not limited to the dual lens configuration shown in FIG. 1.

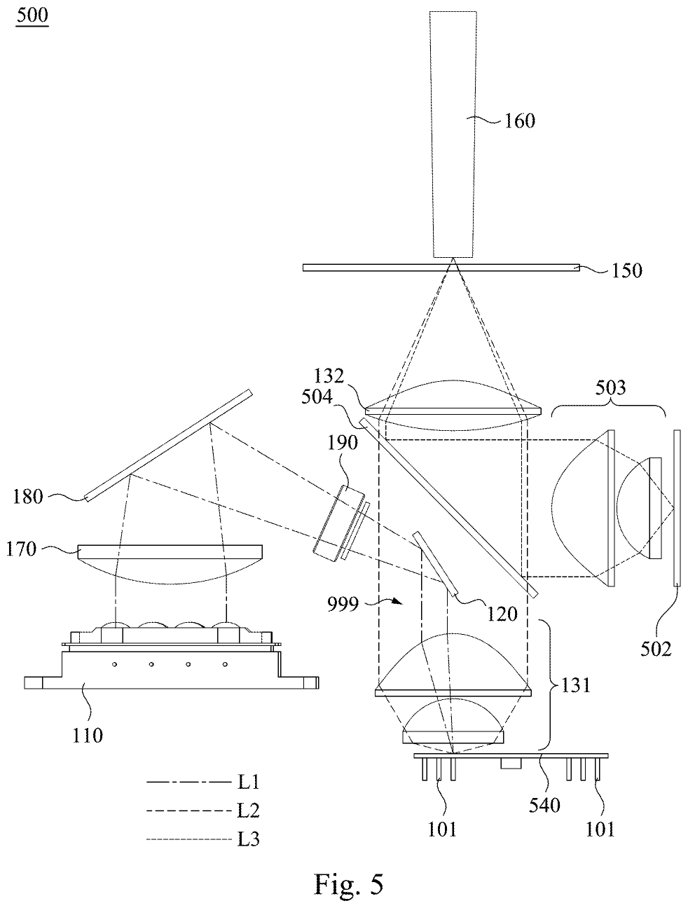

Reference is made to FIG. 5, which illustrates a side view of an illumination system 500 in accordance with another embodiment of the present disclosure. The present embodiment differs from the illumination system 100 shown in FIG. 1 in that the illumination system 500 further includes a second light source 502, a third lens set 503 and a dichroic filter 504. The dichroic filter 504 and the first lens set 131 are located on two opposite sides of the reflective member 120. The second light source 502 is oriented towards a surface of the dichroic filter 504 away from the reflective member 120. The third lens set 503 is located between said surface of the dichroic filter 504 and the second light source 502.

The second light source 502 is a supplementary light source that is configured to emit a fourth light. The fourth light travels along the third light path L3 towards the third lens set 503 and becomes parallel light rays after passing through the third lens set 503. The fourth light next travels towards the dichroic filter 504 and is reflected by the surface of the dichroic filter 504 away from the reflective member 120. The fourth light after reflection and the second light in the light passage region 999 travel in the same direction. The fourth light is then converged by the second lens set 132 to the color wheel 150. With the second light source 502, the phosphor wheel 540 is not required to provide light of all primary colors (e.g., red, green and blue).

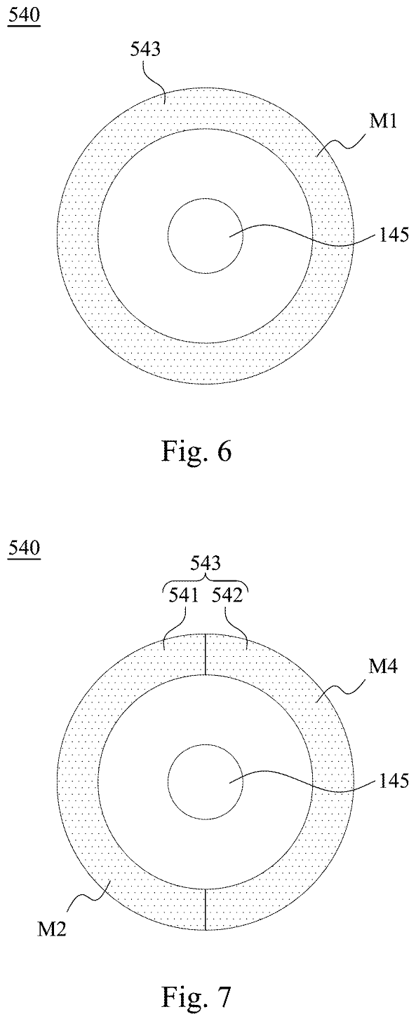

In some embodiments, the second light source 502 is a blue laser. The dichroic filter 504 is configured to reflect blue light and allow light of other colors to pass through. In such embodiments, the illumination system 500 is equipped with the phosphor wheel 540 shown in FIG. 6 to provide red light, green light or mixture thereof. As shown in FIG. 6, the first section 543 of the phosphor wheel 540 is a wavelength conversion section which includes a yellow fluorescent material M1. The first light source 110 may be an ultraviolet laser. The yellow fluorescent material M1 of the first section 543 absorbs at least part of the ultraviolet and emits yellow light. Alternatively, the first section 543 may have two subsections which include a red fluorescent material and a green fluorescent material respectively to provide a red light and a green light.

For the embodiment described in the previous paragraph, the reflective member 120 may be a reflective mirror that is configured to reflect the ultraviolet provided by the first light source 110 and the yellow light (or red light and green light) emitted by the phosphor wheel 540. The reflective member 120 may be a dichroic filter that is configured to reflect the ultraviolet provided by the first light source 110 and allow other light (e.g., visible light) to pass through.

In some embodiments, to increase the brightness of the red light provided by the illumination system 500, the second light source 502 is a red laser and the dichroic filter 504 is configured to reflect red light and allow light of other colors to pass through. In such embodiments, the illumination system 500 is equipped with the phosphor wheel 540 shown in FIG. 7 to provide green light, blue light and mixture thereof. As shown in FIG. 7, the first section 543 of the phosphor wheel 540 is a wavelength conversion section which includes a first subsection 541 and a second subsection 542. The first subsection 541 includes a green fluorescent material M2 and the second subsection 542 includes a blue fluorescent material M4. The first light source 110 may be an ultraviolet laser. The green fluorescent material M2 of the first subsection 541 absorbs at least part of the ultraviolet and emits green light. The blue fluorescent material M4 of the second subsection 542 absorbs at least part of the ultraviolet and emits blue light. Alternatively, the first light source 110 may be a blue laser, and the phosphor wheel 540 may include a reflective section and a green light wavelength conversion section to provide blue light and green light respectively.

For the embodiment described in the previous paragraph, the phosphor wheel 540 may further provide red light. For example, the phosphor wheel 540 may further include a red light wavelength conversion section that is configured to emit a first red light. The second light source 502 is configured to provide a second red light. The first red light and the second red light differ in wavelength. For example, the wavelength of the first red light and the wavelength of the second red light fall within a first wavelength interval and a second wavelength interval respectively, both of which are subintervals of the red light wavelength interval. The dichroic filter 504 is configured to reflect light with wavelength that falls in the second wavelength interval and allow light with wavelength that is outside of the second wavelength interval to pass through. Preferably, the first wavelength interval and the second wavelength interval do not overlap. However, even if the first wavelength interval and the second wavelength interval partially overlap, the illumination system 500 is still able to provide red light with increased brightness as the amount of the second red light provided by the second light source 502 exceeds the amount of first red light lost by reflection. The supplementary light depends on the desired characteristics of the illumination system is not limited to red light.

In sum, the illumination system of the present disclosure is of reflective design. All light paths are located on the receiving side of the phosphor wheel such that there is no need for additional optical components on the rear side of the phosphor wheel. This results in significant reduction in the size, weight and cost of the illumination system, meanwhile providing enough space for the phosphor wheel to dissipate heat.

Although the present disclosure has been described by way of the exemplary embodiments above, the present disclosure is not to be limited to those embodiments. Any person skilled in the art can make various changes and modifications without departing from the spirit and the scope of the present disclosure. Therefore, the protective scope of the present disclosure shall be the scope of the claims as attached.

What is claimed is:

1. An illumination system, comprising:
a first light source configured to emit a first light;
a reflective member configured to reflect at least part of the first light;
a lens set configured to converge the first light reflected by the reflective member; and
a phosphor wheel, wherein the phosphor wheel and the reflective member are positioned on two opposite sides of the lens set, the phosphor wheel has a first section to which the first light converges, the first section is configured to provide a second light, the second light is configured to pass through the lens set to define a light passage region, and the reflective member is at least partially located within the light passage region.

2. The illumination system of claim 1, wherein the first section is a reflective section, and the first light is configured to be reflected by the reflective section to form the second light.

3. The illumination system of claim 2, wherein the phosphor wheel further comprises a second section configured to absorb at least part of the first light and emit a third light, the first light and the third light differs in wavelength, and the third light is configured to pass through the lens set and enter the light passage region.

4. The illumination system of claim 3, wherein each of the first light and the second light is blue light, and the second section comprises at least one of: a red fluorescent material, a green fluorescent material and a yellow fluorescent material.

5. The illumination system of claim 2, wherein the reflective section comprises at least one of: white glue, white glue mixed with fluorescent powder, a fluorescent powder layer, a dielectric coating, a metallic reflective layer and a reflective optical film.

6. The illumination system of claim 2, wherein the phosphor wheel comprises a reflective substrate, and the reflective section is located on the reflective substrate.

7. The illumination system of claim 1, wherein the first section is a wavelength conversion section configured to absorb at least part of the first light and emit the second light, the first light and the second light differ in wavelength.

8. The illumination system of claim 7, wherein the first light is ultraviolet, and the wavelength conversion section comprises at least one of: a red fluorescent material, a green fluorescent material, a blue fluorescent material and a yellow fluorescent material.

9. The illumination system of claim 1, wherein the reflective member is a reflective mirror.

10. The illumination system of claim 1, wherein the reflective member is a beam splitter, the beam splitter has a filtering portion configured to reflect at least part of the first light and allow light of other colors to pass through.

11. The illumination system of claim 10, wherein an area of the filtering portion is less than 70% of a cross sectional area of the light passage region.

12. The illumination system of claim 10, wherein the first section is a reflective section, the first light is configured to be reflected by the reflective region to form the second light, the first light includes a first polarized light, the second light includes the first polarized light and a second polarized light, the second polarized light and the first polarized light have orthogonal directions of polarization, the filtering portion is configured to reflect the first polarized light and to allow the second polarized light to pass through.

13. The illumination system of claim 1, further comprising:
a dichroic filter, wherein the dichroic filter and the lens set are located on two opposite sides of the reflective member; and
a second light source configured to emit a fourth light, wherein the fourth light is configured to be reflected by a surface of the dichroic filter that faces away from the reflective member, and the fourth light after reflection at the surface and the second light in the light passage region travel in the same direction.
